(19) United States
(12) Patent Application Publication
(10) Pub. No.: US 2011/0225332 A1
(43) Pub. Date: Sep. 15, 2011

(54) Data transmission device and control method

(75) Inventors: Mao-Huai Weng, San-Chung City (TW); Hsia-Pin Liao, San-Chung City (TW); Chun-Sung Wu, San-Chung City (TW); Chun-Tai Chen, San-Chung City (TW); Wen-Chu Chuang, San-Chung City (TW)

(73) Assignee: Acard Technology Corp.

(21) Appl. No.: 12/003,854

(22) Filed: Jan. 2, 2008

(51) Int. Cl. G06F 13/00

(52) U.S. Cl. 710/107

(57) ABSTRACT

The present invention provides a data transmission device with high speed serial transmission interfaces and control method thereof, and includes a control unit, at least one first storage device connected to the control unit and at least one second storage device, at least one switching device, which is used to switch data transmission lines; each of the switching devices being connected to the control unit, the second storage device and a computer. Accordingly, the switching devices enable the storage devices to connect to the computer to implement data transmission, or the switching devices switch connection to form an independently operable data transmission control system to enable implementing data transmission between the storage devices. Moreover, an automatic detection mode and a manual mode can be used to control connection to the computer or enable independent operation of the data transmission device.

### BACKGROUND OF THE INVENTION

(a) Field of the Invention

The present invention relates to a data transmission device and control method thereof, and more particularly to a data replication or backup device and connecting method for controlling data transmission.

(b) Description of the Prior Art

The information age has brought about the production and circulation of enormous amounts of data, which has resulted in the ever growing demand for data backup and replication, such as mass CD (Compact Disk) burning and replication or storage backup of computer and network data, restoring of hard disk systems, data replication between multiple disk drives and so on. All of which can be processed using a duplicator or backup control system. Duplicators in the current market are assembled from a controller and a plurality of hard disk drives or CD-ROM (Compact Disc Read-Only Memory) drives, and the controller enables data replication or burning between the hard disk drives or CD-ROM drives.

The development of high speed serial transmission interface technology, SAS (Serial Attached SCSI (Small Computer System Interface)) control interfaces, and SATA (Serial Advanced Technology Attachment) control interfaces have brought about the use of new generation duplicators or data backup systems, which provide faster transmission speed compared to IDE (Integrated Drive Electronics) parallel interfaces.

The duplicator with independently operable SATA or SAS interfaces connect a plurality of SATA or SAS hard disk drives or CD-ROM drives to a SATA or SAS controller by means of SATA or SAS transmission lines to enable data replication or burning between the hard disk drives or CD-ROM drives. However, the duplicator with high speed serial interfaces only enables independent operation. If only one of the SATA or SAS hard disk drive is needed to connect directly to the computer for use thereof and enable data transmission between the computer and the SATA or SAS hard disk drive, then current systems are unable to achieve such functionality, and are thus unable to meet the multifunctional needs of users.

### SUMMARY OF THE INVENTION

A primary objective of the present invention is to provide a data transmission device that enables independent operation of the data transmission device with high speed serial transmission interfaces (SATA or SAS interface) by means of a switching device configured to be able to switch data transmission lines, and that also enables connection to a computer, thereby providing more powerful functionality and enabling faster and easier switching of data transmission lines.

Another objective of the present invention is to provide a control method for data transmission that uses an automatic detection mode and a manual mode to control connection to a computer or enable an independently operable system, thereby providing more flexible and complete control of data transmission.

In order to achieve the aforementioned objectives, the present invention comprises a control unit having a high speed serial transmission interface (SATA or SAS Interface); at least one first storage device connected to the control unit and at least one second storage device, the storage devices are all configured with high speed serial transmission interfaces (SATA or SAS interfaces); and at least one switching device, which is used to switch data transmission lines. Each of the switching devices is connected to the control unit using a first transmission line and a control line. A second transmission line is connected to the second storage device, and a third transmission line is used to connect the switching device to a computer.

When it is required to connect to the computer to transmit data, the control unit enables the second storage devices to be connected to the computer through the switching devices to implement data transmission, or the switching devices switch connection of the second storage devices to the control unit to form an independently operable data transmission control system, thereby enabling data transmission between the first storage devices and the second storage devices. The number of the switching devices matches the number of the second storage devices, and each of the second storage devices must be connected to a switching device to enable connection to a computer through the switching device.

The control method for data transmission of the present invention is divided into an automatic detection mode and a manual mode. When configured in automatic detection mode, the control unit detects whether or not the third transmission line is connected to the computer, and when the third transmission line is connected to the computer, then the switching devices automatically connect the second storage devices to the computer to enable data transmission between the second storage devices and the computer. When the control unit detects that the third transmission line is not connected to the computer, then the switching devices automatically switch connection of the second storage devices to the control unit to form an independently operable data transmission control system, thereby enabling data transmission between the first storage devices and the second storage devices.

When configured in manual mode, the control unit produces a control signal which is transmitted through the control line to switch the switching devices. When it is required to connect to the computer, then the control signal switches the switching devices to enable the second storage devices to connect to the computer, thereby enabling the computer to access the second storage devices. When an independently operable data transmission control system is required, then the control signal switches the switching devices to enable the second storage devices to connect to the control unit through the switching device, thereby enabling data transmission between the first storage devices and the second storage devices, and thus providing data backup or CD burning functionality.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 shows a schematic block diagram of a first embodiment of a data transmission device of the present invention.

FIG. 2 shows a flow chart depicting automatic detection mode according to the present invention.

FIG. 3 shows a flow chart depicting manual mode according to the present invention.

FIG. 4 shows a schematic block diagram of a second embodiment of the data transmission device of the present invention.

### DETAILED DESCRIPTION OF THE PREFERRED EMBODIMENTS

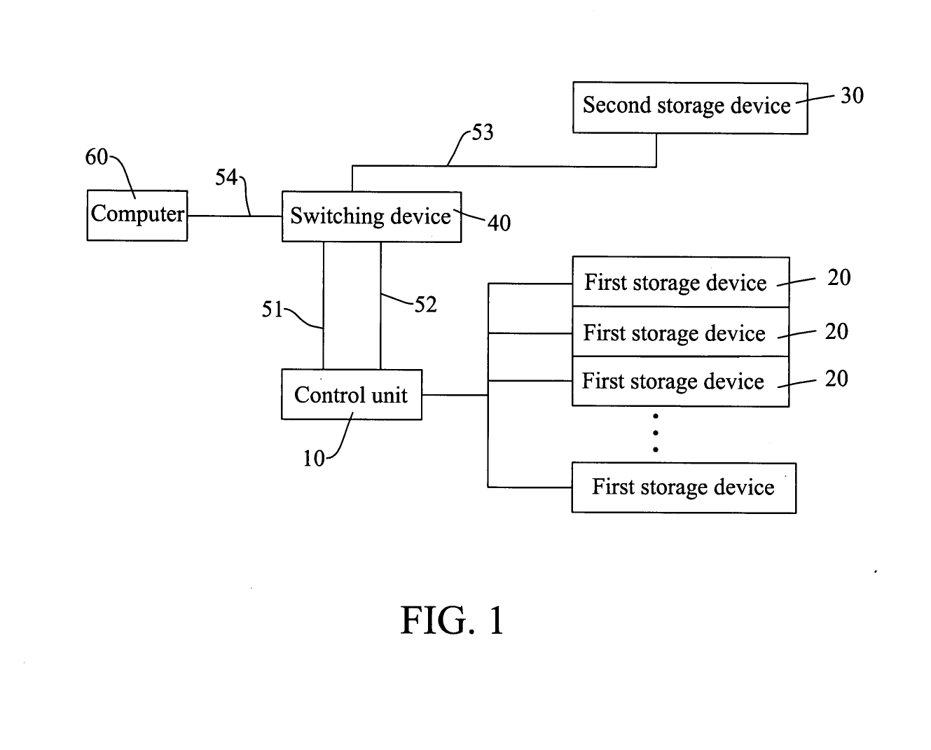

Referring to FIG. 1, which shows a schematic block diagram of a first embodiment of a data transmission device of the present invention, wherein the present invention comprises a control unit 10, at least one first storage device 20 and at least one second storage device 30. The first storage device 20 is connected to the control unit 10, and in the first embodiment a plurality of the first storage devices 20 are configured. A switching device 40 is used to switch data transmission lines. A first transmission line 51 and a control line 52 are used to connect the switching device 40 to the control unit 10, a second transmission line 53 connects the switching device 40 to the second storage device 30, and a third transmission line 54 is used to connect the switching device 40 to a computer 60. When the computer 60 is transmitting data, the switching device 40 enables the second storage device 30 to connect to the computer 60 to implement data transmission, or the switching device 40 switches connection of the second storage device 30 to the control unit 10 to form an independently operable data transmission control system, thereby enabling data transmission between the first storage devices 20 and the second storage device 30.

The first transmission line 51 and the second transmission line 53 are high speed serial transmission interfaces, and can be SATA transmission lines, or SAS transmission lines. The third transmission line 54 can use a transmission interface such as a USB transmission interface or an eSATA, or a SAS, but are not limited to such interfaces.

The aforementioned first storage devices 20 and the second storage device 30 are hard disks or CD-ROM drives having a high speed serial transmission interface; the high speed serial transmission interface being a SATA interface or SAS interface.

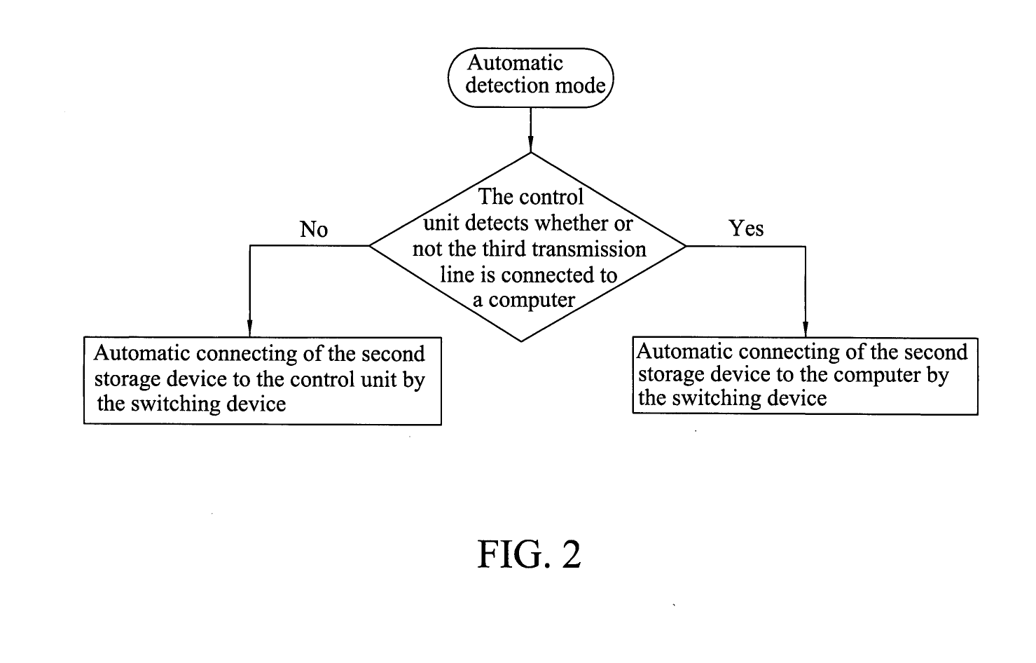

A control method for data transmission of the present invention is divided into an automatic detection mode and a manual mode. When configured in automatic detection mode, referring to FIG. 2, the control unit 10 detects whether or not the third transmission line 54 is connected to the computer 60, and when the third transmission line 54 is connected to the computer 60, then the switching device 40 automatically connects the second storage device 30 to the computer 60 to enable data transmission between the second storage device 30 and the computer 60. When the control unit 10 detects that the third transmission line 54 is not connected to the computer 60, then the switching device 40 automatically switches connection of the second storage device 30 to the control unit 10 to form an independently operable data transmission control system, thereby enabling data transmission between the first storage devices 20 and the second storage device 30.

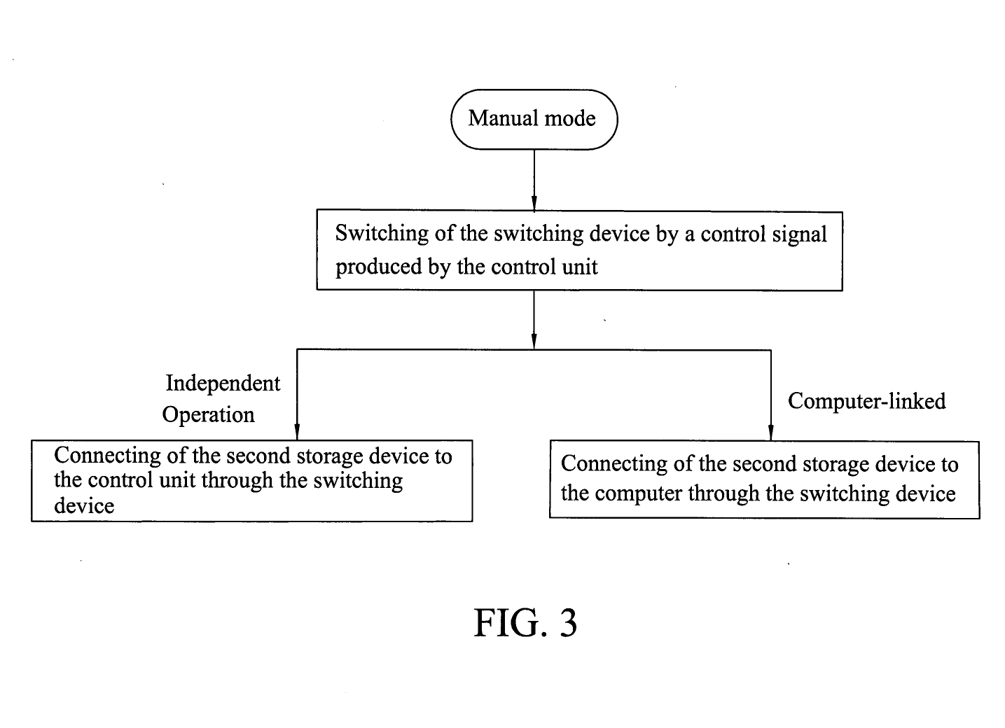

When configured in manual mode, referring to FIG. 3, the control unit 10 produces a control signal which is transmitted through the control line 52 to switch the switching device 40. When it is required to connect to the computer 60, then the control signal switches the switching device 40 to enable the second storage device 30 to connect to the computer 60, thereby enabling the computer 60 to access the second storage device 30 and implement data transmission between the second storage device 30 and the computer 60. When an independently operable data transmission control system is required, then the control signal switches the switching device 40 to enable the second storage device 30 to connect to the control unit 10 through the switching device 40, thereby enabling data transmission between the first storage devices 20 and the second storage device 30, and thus providing data backup or CD burning functionality.

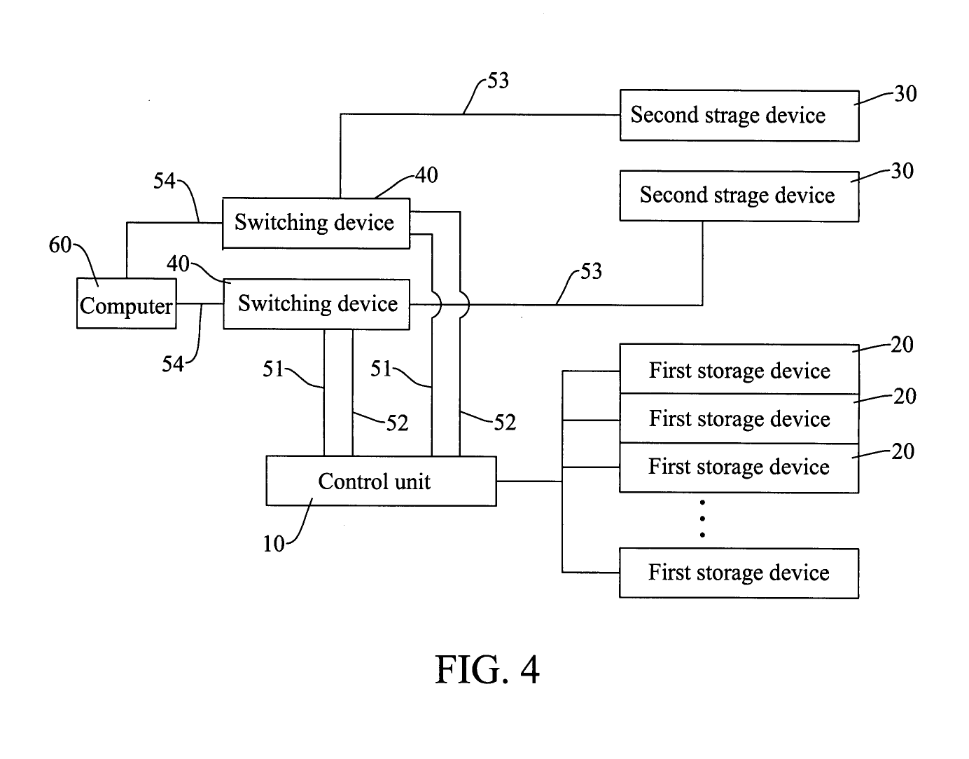

Referring to FIG. 4, which shows a schematic block diagram of a second embodiment of the data transmission device of the present invention, and depicts a data transmission architecture structured from a plurality of storage devices connected to the computer 60, wherein the second embodiment comprises the control unit 10, at least one first storage device 20 and a plurality of the second storage devices 30. The first storage devices 20 are connected to the control unit 10, and in the second embodiment a plurality of the first storage devices 20 are configured. A plurality of the switching devices 40 are used to switch data transmission lines, and the switching devices 40 respectively use the first transmission lines 51 and the control lines 52 to connect to the control unit 10. The second transmission lines 53 are respectively connected to the second storage devices 30, and the third transmission lines 54 are used to respectively connect to the computer 60. When transmitting data to the computer 60, the switching devices 40 enable the second storage devices 30 to connect to the computer 60 to implement data transmission, or the switching devices 40 switch connection and enable the second storage devices 30 to connect to the control unit 10 and form an independently operable data transmission control system to enable data transmission between the first storage devices 20 and the second storage devices 30. The number of the switching devices 40 is configured to match the second storage devices 30, that is, a separate switching device 40 must be configured to function in conjunction with each one of the second storage devices 30 wanting to connect to the computer 60. The control method for data transmission of the second embodiment is the same as that of the first embodiment, whereby the control unit 10 is similarly switched via the automatic detection mode or manual mode to enable the second storage devices 30 to connect to the computer 60, or enables the second storage devices 30 to connect to the control unit 10 to form an independently operable data transmission control system.

Using structural disposition of the switching devices 40, the present invention is able to provide a data transmission system with high speed serial transmission interfaces (SATA or SAS interfaces) that is independently operable or computer-linked, and enables more powerful and practical functionality. Moreover, switching control is fast and easy, and the structural architecture is simple, and thus complies with the essential elements as required for a new patent application.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A data transmission device, used to enable devices having high speed serial transmission interfaces to connect to a computer, or enable independent operation to implement data replication; comprising:
a control unit with a high speed serial transmission interface;
at least one first storage device connected to the control unit;
at least one second storage device; and
at least one switching device used to switch data transmission lines;
wherein each of the switching devices uses a first transmission line and a control line to connect to the control unit, second transmission lines respectively connect the switching devices to the second storage devices, and third transmission lines are used to respectively connect the switching devices to a computer;
whereby the switching devices enable independent operation of the data transmission device by switching to implement data replication between the first storage devices and the second storage devices, or switch connection to a computer to enable data access between the computer and the second storage devices.

2. The data transmission device according to claim 1, wherein the first storage devices, the second storage devices, the first transmission lines and the second transmission lines are high speed serial transmission interfaces.

3. The data transmission device according to claim 1, wherein the high speed serial transmission interfaces are SATA (Serial Advanced Technology Attachment) interfaces.

4. The data transmission device according to claim 2, wherein the high speed serial transmission interfaces are SATA (Serial Advanced Technology Attachment) interfaces.

5. The data transmission device according to claim 1, wherein the high speed serial transmission interfaces are SAS (Serial Attached SCSI (Small Computer System Interface)) transmission interfaces.

6. The data transmission device according to claim 2, wherein the high speed serial transmission interfaces are SAS (Serial Attached SCSI (Small Computer System Interface)) transmission interfaces.

7. The data transmission device according to claim 1, wherein the first storage devices and the second storage devices are hard disk drives or CD-ROM (Compact Disc Read-Only Memory) disk drives.

8. The data transmission device according to claim 1, wherein the third transmission line is a USB (Universal Serial Bus) or eSATA (External Serial Advanced Technology Attachment) or a serial SCSI transmission interface.

9. A control method for data transmission, which enables devices having high speed serial transmission interfaces to connect to a computer to implement data transmission, or enable independent operation to implement data replication; wherein the method connects first storage devices to a control unit, the control unit is connected to a switching device, and the switching device is connected to a second storage device, and a transmission line is used to connect the switching device to a computer; the control unit uses an automatic detection mode and a manual mode to effect switching of the switching device, thereby enabling the second storage device to connect to the computer or enable the second storage devices to connect to the control unit.

10. The control method for data transmission according to claim 9, wherein when configured in automatic detection mode, the control unit detects whether or not the transmission line is connected to the computer, and when the transmission line is connected to the computer, then the switching device automatically connects the second storage device to the computer to enable data transmission between the second storage device and the computer; when the control unit detects that the transmission line is not connected to the computer, then the switching device automatically switches connection of the second storage device to the control unit to form an independently operable data transmission control system, thereby enabling data transmission between the first storage devices and the second storage device.

11. The control method for data transmission according to claim 9, wherein when configured in manual mode, the control unit produces a control signal that switches the switching device, and when it is required to connect to a computer, then the control signal switches the switching device to enable the second storage device to connect to the computer, thereby enabling the computer to access the second storage device and implement data transmission between the second storage device and the computer; when an independently operable data transmission control system is required, then the control signal switches the switching device to enable the second storage device to connect to the control unit through the switching device, thereby enabling data transmission between the first storage devices and the second storage device, and thus providing data backup or CD burning functionality.
